(19) United States
(12) Patent Application Publication
(10) Pub. No.: US 2005/0231957 A1
(43) Pub. Date: Oct. 20, 2005

(54) Light beam shaping apparatus

(76) Inventor: Peter Wynne Willson, London (GB)

Correspondence Address: MARSHALL, GERSTEIN & BORUN LLP, 233 S. WACKER DRIVE, SUITE 6300, SEARS TOWER, CHICAGO, IL, 60606, US

(21) Appl. No.: 10/519,307

(22) PCT Filed: Jun. 23, 2003
(86) PCT No.: PCT/GB03/02683

§ 371 Date: Jun. 20, 2005

(30) Foreign Application Priority Data
Jun. 21, 2002 (GB) 0214431.9

(51) Int. Cl. F21V 17/02

(52) U.S. Cl. 362/322

(57) ABSTRACT

Apparatus for shaping a light beam in a lighting device comprising an occluding element which is rotatable about an axis parallel to the light beam, the axis of rotation of the occluding element being independently movable along a path so as to provide a large number of possible lighting effects.

This invention is directed to the creation of lighting effects, and in specific examples, to framing techniques.

There are currently various known methods for creating lighting displays from a light beam and an apparatus occluding the beam. For example the beam may be modulated by one or more sliding shutters, to create a particular size of rectangular frame, or shaped slides may be used to produce patterns or shapes in the projected light.

It is an object of the present invention to provide lighting displays which are more effective, more reliable, and more eye-catching than those produced by previous devices, and to produce new lighting displays and effects.

Accordingly, the invention consists in one aspect in apparatus for framing a light beam in a lighting device, comprising at least two occluding elements separately movable in a plane orthogonal to the axis of the light beam for varying the shape of the beam, at least one of which elements being revolvable about the axis of the light beam.

The invention is thus more effective in occluding a light beam than known sliding frames, and is able to provide a wide variety of new and complex displays and effects.

Advantageously, each of the elements are revolvable relative to one another. The combination of the revolving elements allows greater diversity in creating lighting displays. The elements may rotate or orbit about the axis of the beam, or indeed, remain stationary, and may move in any cooperative combination of these. Translating movements such as those produced by known sliding frame devices may be replicated by combination of the rotation or orbit of the elements.

In one form of the invention, at least one of the elements is revolvable about an axis distinct from that of the beam. Thus one of the elements may rotate or orbit independently of another, allowing a further order of combinations of movement.

In a particular embodiment, the apparatus comprises a first support housing a first element and a second support housing a second element, the first and second supports being situated one in front of the other along the axis of the beam. The number of elements combined in this arrangement may vary, creating more or less complex displays. The effect produced by each element may be used in combination, along with the combinations of revolving movement available.

Preferably, the supports each comprise a first and a second revolvable plate, one of which plates housing or forming the occluding element. In one form of this embodiment, the first, inner plate houses (or forms) the element, and is eccentric to the second, outer plate, allowing it to orbit the axis of the first plate. Suitably, the second plate is able to orbit the axis of the beam. Thus the outer plate may either rotate or orbit the beam axis, according to the effect desired.

Preferably, the first plate is substantially circular and is cammed within a substantially circular cavity in the second plate.

The invention will now be described by way of example with reference to the accompanying drawings, in which:

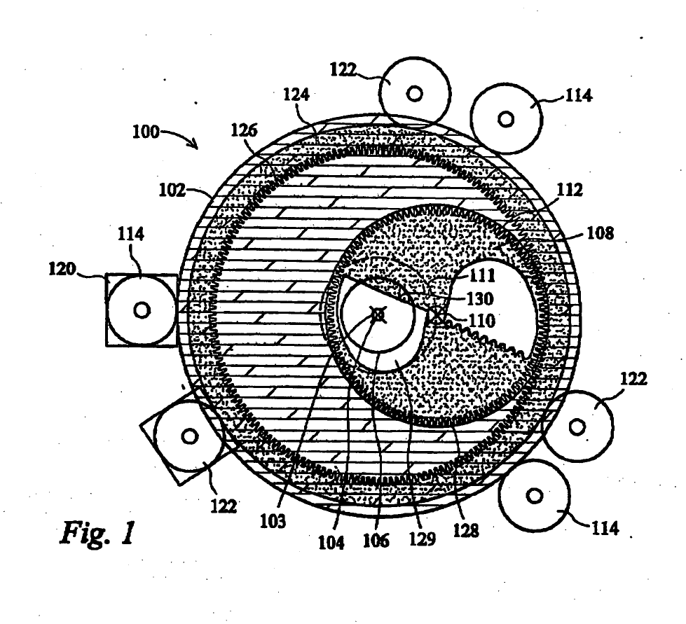

FIG. 1 is a diagram illustrating framing apparatus according to an embodiment of the invention;

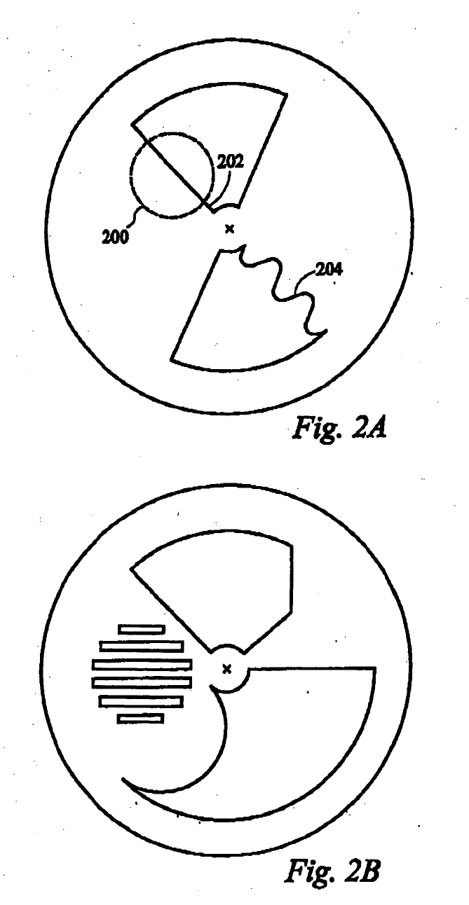

FIGS. 2a and 2b are diagrams illustrating occluding elements according to embodiments of the invention;

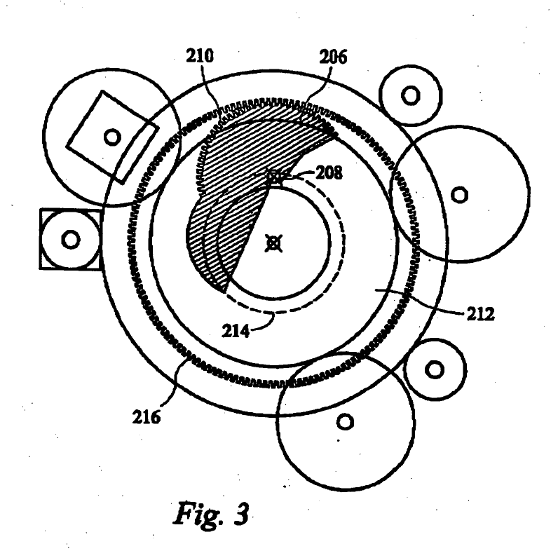

FIG. 3 is a diagram illustrating framing apparatus according to another embodiment of the invention;

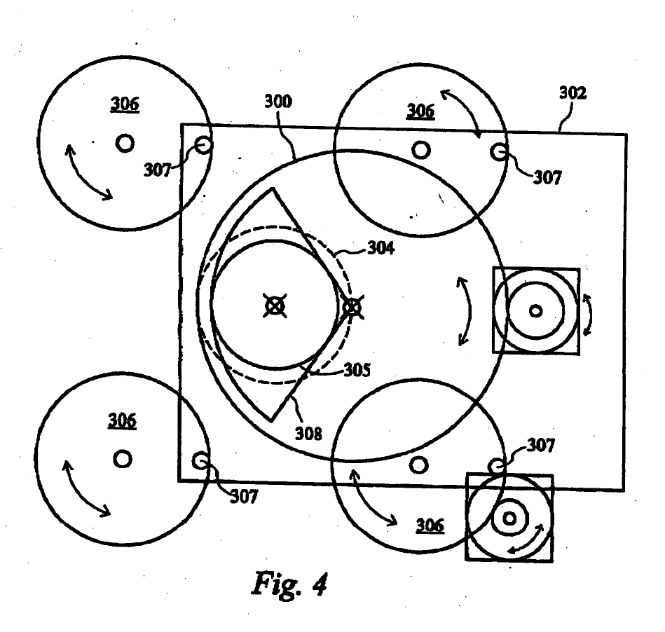

FIG. 4 is a diagram illuminating framing apparatus according to a further embodiment of the invention; and

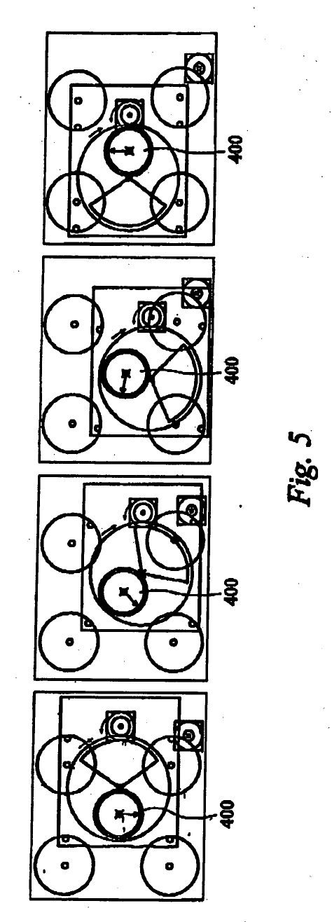

FIG. 5 is a diagram illustrating the operation of the apparatus shown in FIG. 4, according to a particular embodiment.

FIG. 1 illustrates an example of a framing device (100), according to a specific embodiment, having a set of two cooperatively revolving discs. An outer disc (102) is mounted in front of the light source, which produces the light beam whose axis (104) coincides with the axis of rotation of the outer disc (103), and whose projection is shown at 106. An inner disc (108), whose axis of rotation is shown at (110), and whose path of orbit is indicated at (111), is also mounted an the device. In this case, the inner disc is located within a cavity (112) in the outer disc, in order that the device (100) is as thin as possible (so that it projects as little as possible out of its plane). In alternative embodiments, the inner disc is mounted on top of the outer disc.

The outer disc (102) is rotated about its axis (103) by a gear set (114), whose gear teeth (not shown) mesh with a set of teeth (not shown) disposed on the circumference of the outer disc. The rotation is driven by a motor (120) on one of the gears. The inner disc is driven by a similar set of gears (122) which drive an upper ring (124) having an inner set of teeth (126) which mesh with those (128) of the inner disc. The inner disc protrudes from the plane of the outer disc, to meet the upper ring. Thus, no matter where, within it orbital path inside the outer disc, the inner disc is located, the teeth of the upper ring will mesh with at least some of the inner disc's teeth (128).

Hence, either of the inner or outer discs may be rotated independently of each other, or they may be rotated together. It will be seen that, as the inner disc is contained within cavity (112) of the outer disc, a rotation of the outer disc will produce an orbit of the inner disc around its orbital path (111).

The inner disc comprises an aperture (129), in order that the light beam may be permitted through the device, and an occluding element (130), which may be integral to the disc, or removably mounted upon it, for producing the variety of displays or effects. For example, if the occluding element is a simple blade type as shown here, a rotation of the inner disc will move the blade around the perimeter of the light beam (108). A rotation of the outer disc alone will sweep the blade across the light beam, as the inner disc orbits. A combination of the two rotations will produce a variety of combinations of these two effects.

The occluding element may, of course, take a variety of forms and shapes, providing a wide variety of different displays when moved with the two rotating discs. For example, the device may be larger or smaller, varying the relative size of the light beam to the device. In one embodiment as illustrated in FIG. 2a, the light beam is small enough relative to the device that its projection (200) covers no more than half the diameter of the inner disc. This entails that the inner disc may have two different shapes or profiles, 202 and 204, at either end of the occluding element. When the outer disc is positioned accordingly, the inner disc is positioned such that the first shape occludes the beam, and in turn, another position enables the other shape to occlude the beam. Of course, in other embodiments, the occluding element is not so large, and thus, where the light beam is larger than half the diameter of the element, may provide a single display effect only.

The occluding element may also incorporate a wide variety of different shapes or profiles, such as those illustrated, for example, in FIG. 2b. When the inner disc is revolved, the different profiles can be used to modulate the light beam, to the extent and in the direction determined by the revolving motions of the device.

In other alternative embodiments, the occluding element is provided alone, rather than being mounted on or formed as part of an inner disc. For example, in one embodiment as shown in FIG. 3, the occluding element (208) is a simple blade-type, and is mounted by a pivot (208) on the outer disc (212), in order to allow rotation. This pivot is at a similar location on the outer disc to the axis of rotation of the inner disc in the above described embodiment. The element (206) has a set of teeth (210) along one edge (equivalent to those provided along the circumference of the above inner disc) which mesh with the outer drive gear (216), to provide the rotation. When the outer disc (212) is rotated, the element (206) orbits around the path 214, and, as before, the combination of these two revolving movements provides a variety of display effects using the element (206).

It should be noted, of course, that any shape may be provided for the occluding element, or its support. In the embodiments described, the circular nature of the two elements, the outer and inner discs, enables their being driven by the gear sets described. However, the outer and inner elements may be driven in their rotation or orbit by other means which do not require the circular shape.

In an embodiment of the invention, a set, typically of four, such devices is combined, one in front of another along the axis of the light beam. This adds still more variety to the displays which may be achieved. For instance, the four devices could replicate a simple four blade framing display, simply by rotating each outer disc alone, with a simple blade-shaped occluding element on each inner disc. The set could also produce an iris display, with each occluding element formed into an arc, and the combined revolving motions converging or diverging the arcs.

In an alternative embodiment, as illustrated in FIG. 4, the inner disc (300) is rotated within an outer element (302), which is orbited, rather than being rotated, about a path (304) around the axis of the light beam (305). The orbit is driven by motorized wheel-and-crank mechanisms (306) attached (307) to the outer element. The occluding element (308) of the inner disc (300) may then be moved across the light beam in the variety of motions allowed for by the combination of the orbit of the outer disc and the rotation of the inner disc. Other effects may also be achieved, with various occluding elements on the inner disc. For example, an element (400) on the inner circle may be maintained over the light beam (305), and rotated, as shown in the sequence depicted in FIG. 5.

This apparatus is also typically combined with other devices, typically in a set of four in a stack in front of the light beam, to produce a different variety of displays.

In other embodiments, other combinations of the revolving motions, either rotating or orbiting, of the discs are employed. In an example the inner disc is able to orbit around a path independent of that orbit caused by the rotation or orbit of the outer disc. Occluding elements may also be incorporated into the outer disc or element of the embodiments described, providing further displays or effects which may interact with those provided by the inner disc.

In alternative embodiments to hose described above, the occluding elements on the devices may incorporate slides or gobos for producing a specific single shape or pattern in the projected light. These slides or gobo may be moved across or around the light beam, in any of the wide variety of paths allowed by the combination of revolutions available to the device. For instance, a particular shape may be provided by a gobo, and the shape may be made to ‘dance’ across the light beam, by combinations of offsetting to the centre of the beam, simple translational movement, rotating to particular angles and orbiting the beam axis. Slides mounted on different devices in a set of four may be combined and moved or rotated in combination, to eye-catching effect. For instance, a complete clock face effect could be created, with each device providing separate moving features.

In embodiments, the devices are mounted on a mechanism for moving them along the axis of the light beam, producing, for example, zooming and blurring effects. In a set of devices, each device may move cooperatively with, or independently of, the other devices.

It will be appreciated by those skilled in the art that the invention has been described by way of example only, and that a wide variety of alternative approaches may be adopted without departing form the scope of the appended claims.

1. Apparatus for framing a light beam in a lighting device, comprising at least two occluding elements separately movable in a plane orthogonal to the axis of the light beam for varying the shape of the beam, at least one of which elements being revolvable about the axis of the light beam.

2. Apparatus according to claim 1, wherein each of the elements is revolvable relative to one another.

3. Apparatus according to claim 1, wherein at least one of the elements is revolvable about an axis distinct from that of the beam.

4. Apparatus according to claim 1, comprising a first support housing a first element and a second support housing a second element, the first and second supports being situated one in front of the other along the axis of the beam.

5. Apparatus according to claim 4, wherein the supports each comprise a first and a second revolvable plate, one of which plates houses the occluding element.

6. Apparatus according to claim 5, wherein the first, inner plate houses the element, and is eccentric to the second, outer plate, allowing it to orbit the axis of the first plate.

7. Apparatus according to claim 5, wherein the second plate is able to orbit the axis of the beam.

8. Apparatus according to claim 5, wherein the first plate is substantially circular and is cammed within a substantially circular cavity in the second plate.

9. Apparatus for shaping a light beam in a lighting device, comprising a planar occluding element arranged in a plane generally orthogonal to the axis of the light beam, wherein the occluding element is rotatable about a first axis, and wherein said first axis is parallel to the axis of the light beam and moveable in a path offset from the axis of the light beam.

10. Apparatus according to claim 9, wherein the first axis is movable in a circular orbit about the axis of the light beam.

11. Apparatus according to claim 9, further comprising a support disc disposed parallel to the occluding element and rotatable about the axis of the light beam, and wherein said occluding element is rotatably mounted to the support disc, the axis of rotation of the occluding element being offset from the axis of rotation of the support disc.

12. Apparatus according to claim 11, wherein the occluding element and the support disc are coplanar
